(19) United States
(12) Patent Application Publication
(10) Pub. No.: US 2008/0182639 A1
(43) Pub. Date: Jul. 31, 2008

(54) LOTTERY TERMINAL

(76) Inventors: Konstantinos Antonopoulos, Athens (GR); Georgios Plakas, Athens (GR); Konstantinos Vrahatis, Athens (GR); Georgios Kolios, Athens (GR); Stavros Liapis, Athens (GR)

Correspondence Address: GREENBERG TRAURIG, LLP, MET LIFE BUILDING, 200 PARK AVENUE, NEW YORK, NY, 10166, US

(21) Appl. No.: 11/750,168

(22) Filed: May 17, 2007

(30) Foreign Application Priority Data
Jan. 30, 2007 (GR) 20070100053
Feb. 22, 2007 (GR) 20070600031

(51) Int. Cl. G06F 17/00

(52) U.S. Cl. 463/17

(57) ABSTRACT

One embodiment of the present invention provides a lottery terminal designed in such a way that the touch screen and the printer cover can provide a double inclination (e.g., the printer cover may be attached to a base and may pivot relative to the base and the touch screen may be attached to the printer cover and may pivot relative to the printer cover). Another embodiment of the present invention provides an internal design that allows the lottery terminal to be ventilated without the need for fans (e.g., allowing essentially silent terminal operation). For example, the motherboard, CPU and chipset heat sink design, in conjunction with the internal configuration and the external design may allow the lottery terminal to be ventilated via use of one or more holes in the bottom and the back side of the lottery terminal.

### CROSS-REFERENCE TO RELATED APPLICATIONS

This application claims priority to Greek Application Serial No. 20070100053, filed Jan. 30, 2007. This application also claims priority to Greek Application Serial No. 20070600031, filed Feb. 22, 2007. The entire content of each of the aforementioned applications is expressly incorporated by reference herein.

### FIELD OF THE INVENTION

One embodiment of the present invention relates to a lottery terminal.

In one particular example, the lottery terminal may be a compact, low-end (e.g., relatively inexpensive) lottery terminal.

For the purposes of describing and claiming the present invention the term “lottery terminal” is intended to refer to a terminal that is used for lottery applications (e.g., scanning information from a lottery slip containing a customer's desired numbers, registering numbers from scanned lottery slips with a remote central database (via a network such as an intranet or the Internet), manually entering a customer's desired numbers, registering manually entered numbers with a remote central database (via a network such as an intranet or the Internet), printing lottery tickets/receipts based on the scanned and/or manually entered numbers, scanning information from printed lottery tickets/receipts, manually entering information from printed lottery tickets/receipts, validating winning tickets/receipts (via a network such as an intranet or the Internet), and/or paying winnings based on the validated winning tickets/receipts) and that may also be used for monetary applications (e.g., retail point-of-sale (“POS”) scanner/cash register).

### BACKGROUND OF THE INVENTION

Various lottery-related terminals and POS machines have been proposed. Examples include what is described in the disclosures of the following patent and patent application publications:

United States Patent Application Publication 2001/0006181, in the name of Roberts, et al., relates to a counter-top ticket display, writing stand and method. More particularly, this reference relates to lottery ticket dispensing housings provided with a hinged, transparent rear and top cover, a hinged front wall, and a powered ticket drive and separator module. A relatively tall embodiment of the dispenser with a small footprint is fitted onto the countertop of a check-out counter of a retail store. The top of the housing is flat so as to provide a convenient place for customers to write checks with the tickets being displayed immediately below being highly visible to the customer. A display of relatively flat and short dispensers is provided wherein a rack or housing supports the dispensers one a top of the other in a vertical array. In such a rack or housing the units are connected together electrically in a daisy-chain manner and one control device (point-of-sale terminal, computer or on-line terminal) operates all connected dispensers. The dispensers are shifted laterally with respect to one another as to give greater viewability of the contents of each of the dispensers to a customer. The length of each dispenser can be decreased with the increasing elevation of the dispenser so as to provide a vertical alignment of the front sides of the dispensers, the side through which tickets are dispensed. A ticket drive and dispensing module is provided which will fit into any of the housings with a minimum of mounting effort or hardware. This relatively flat and short dispenser can also be mounted vertically on a wall or a stand to provide additional convenient installation operations. In such case multiple units are to be daisy-chained together as described above and one control device operates the connected dispensers.

United States Patent Application Publication 2001/0034263, in the name of Roberts, relates to a gaming system and method. More particularly, this reference relates to a gaming system that operates a lottery system for a single state, or includes multiple state systems, each having many different instant-winner ticket games and distributed ticket dispensers. A supervisory computer system is provided. A jackpot is provided which increases with the sale of each ticket in the system. The dispensers have code readers which are used to detect the sale of each ticket. The game is won when the code number detected by one of the code readers matches the code for a jackpot winner.

United States Patent Application Publication 2001/0048013, in the name of Roberts, et al., relates to a ticket dispensing device, installation and displays. More particularly, this reference relates to lottery ticket dispensing housings provided with a hinged, transparent rear and top cover, a hinged front wall, and a powered ticket drive and separator module. A relatively tall embodiment of the dispenser with a small footprint is fitted onto the countertop of a check-out counter of a retail store. The top of the housing is flat so as to provide a convenient place for customers to write checks with the tickets being displayed immediately below being highly visible to the customer. A display of relatively flat and short dispensers is provided wherein a rack or housing supports the dispensers one a top of the other in a vertical array. In such a rack or housing the units are connected together electrically in a daisy-chain manner and one control device (point-of-sale terminal, computer or on-line terminal) operates all connected dispensers. The dispensers are shifted laterally with respect to one another to as to give greater viewability of the contents of each of the dispensers to a customer. The length of each dispenser can be decreased with the increasing elevation of the dispenser so as to provide a vertical alignment of the front sides of the dispensers, the side through which tickets are dispensed. A ticket drive and dispensing module is provided which will fit into any of the housings with a minimum of mounting effort or hardware. This relatively flat and short dispenser can also be mounted vertically on a wall or a stand to provide additional convenient installation operations. In such case multiple units are to be daisy-chained together as described above and one control device operates the connected dispensers.

United States Patent Application Publication 2005/0190533, in the name of Hultzman, et al., relates to a friction hinge assembly and display tilt device. More particularly, this reference relates to a lottery ticket terminal. The lottery ticket terminal includes a friction hinge assembly wherein the friction hinges are configured to be disposed at a distance from a pivot point at which two objects are pivotably connected.

United States Patent Application Publication 2006/0081674, in the name of Roberts, et al., relates to a ticket dispensing device, installation and displays. More particularly, this reference relates to lottery ticket dispensing housings provided with a hinged, transparent rear and top cover, a hinged front wall, and a powered ticket drive and separator module. A relatively tall embodiment of the dispenser with a small footprint is fitted onto the countertop of a check-out counter of a retail store. The top of the housing is flat so as to provide a convenient place for customers to write checks with the tickets being displayed immediately below being highly visible to the customer. A display of relatively flat and short dispensers is provided wherein a rack or housing supports the dispensers one a top of the other in a vertical array. The dispensers are shifted laterally with respect to one another so as to give greater viewability of the contents of each of the dispensers to a customer. The length of each dispenser can be decreased with the increasing elevation of the dispenser so as to provide a vertical alignment of the front sides of the dispensers, the side through which tickets are dispensed. A ticket drive and dispensing module is provided which will fit into any of the housings with a minimum of mounting effort or hardware. This relatively flat and short dispenser can also be mounted vertically on a wall or a stand to provide additional convenient installation operations.

United States Patent Application Publication 2006/0293783, in the name of Hand, et al., relates to an intelligent cash control system. More particularly, this reference relates to a lottery terminal or kiosk such as a video lottery terminal, a lottery ticket printing terminal and/or other remotely controlled retail or gaming kiosk, which allows for transactions of the type in which a user can deposit currency that is validated by a bill validator, and valid currency is stored in an intelligent cash box within the kiosk. The kiosk system then credits the user with credits equal to the amount received to allow the purchase of selected items such as lottery tickets. The system includes the components necessary to allow the selection and printing of lottery tickets, or other vended items, as appropriate. The system also includes the components necessary to allow independent monitoring of the intelligent cash box memory from a remote site. The memory of the intelligent cash box can be accessed and monitored through the bill validator by means of IrDA, RFID, or other wireless means.

U.S. Pat. No. 7,032,793, in the name of Roberts, et al., relates to a ticket dispensing device, installation and displays. More particularly, this reference relates to lottery ticket dispensing housings provided with a hinged, transparent rear and top cover, a hinged front wall, and a powered ticket drive and separator module. A relatively tall embodiment of the dispenser with a small footprint is fitted onto the countertop of a check-out counter of a retail store. The top of the housing is flat so as to provide a convenient place for customers to write checks with the tickets being displayed immediately below being highly visible to the customer. A display of relatively flat and short dispensers is provided wherein a rack or housing supports the dispensers one a top of the other in a vertical array. The dispensers are shifted laterally with respect to one another to as to give greater viewability of the contents of each of the dispensers to a customer. The length of each dispenser can be decreased with the increasing elevation of the dispenser so as to provide a vertical alignment of the front sides of the dispensers, the side through which tickets are dispensed. A ticket drive and dispensing module is provided which will fit into any of the housings with a minimum of mounting effort or hardware. This relatively flat and short dispenser can also be mounted vertically on a wall or a stand to provide additional convenient installation operations.

### BRIEF DESCRIPTION OF THE DRAWINGS

FIG. 1 shows a perspective view of a lottery terminal according to one embodiment of the present invention (wherein a touch screen is rotated upward to a desired orientation and wherein a printer cover to which the touch screen is attached is in a closed position);

FIG. 2 shows another perspective view of the lottery terminal of FIG. 1 (wherein the touch screen is rotated downward and the printer cover to which the touch screen is attached is rotated open to a desired orientation);

FIG. 3 shows another perspective view of the lottery terminal of FIG. 1 (wherein the touch screen is rotated upward to a desired orientation (away from the printer cover) and the printer cover to which the touch screen is attached is rotated open to a desired orientation—this shows that the touch screen does not need to be adjusted in order to change the roll of paper);

FIG. 4 shows a rear view of the lottery terminal of FIG. 1 (wherein the touch screen and the printer cover are rotated downward); and

FIG. 5 shows a cut-away side view of the lottery terminal of FIG. 1 (wherein the touch screen is rotated upward to a desired orientation, wherein the printer cover is in a closed position and wherein an example air flow up from the bottom out through the back of the lottery terminal is shown).

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

As described herein, various embodiments of the present invention integrate numerous lottery terminal peripherals (and, optionally, monetary abilities such as point-of-sale scanner/cash register) into one compact, ergonomic and low-end (e.g., relatively inexpensive) terminal (requiring minimal free space for proper installation and operation).

Of note, the ergonomic design in conjunction with the integrated small size peripherals of certain embodiments may give the flexibility and the robustness of a conventional lottery terminal in a smaller package.

In one specific example, a lottery terminal according to the present invention may provide functionality similar to a conventional lottery terminal at just ¼ of the size of such a conventional lottery terminal (thus providing the flexibility for placing and operating the terminal in places with limited space for operation).

Further, the peripheral integration may provide easy access to the internal components for service.

Further still, the internal design may allow the lottery terminal to be ventilated without the need for fans (e.g., allowing essentially silent terminal operation). For example, the motherboard, CPU and chipset heat sink design, in conjunction with the internal configuration and the external design may allow the lottery terminal to be ventilated via use of one or more holes in the bottom and the back side of the lottery terminal.

Further still, the touch screen may be mechanically attached in such a way as to provide inclination by the operator at any desirable angle during operation.

Moreover, the overall external and internal design of certain embodiments may help to ensure the protection of various lottery terminal parts from access by unauthorized personnel (e.g., parts related to monetary transactions and/or winning ticket/receipt validation).

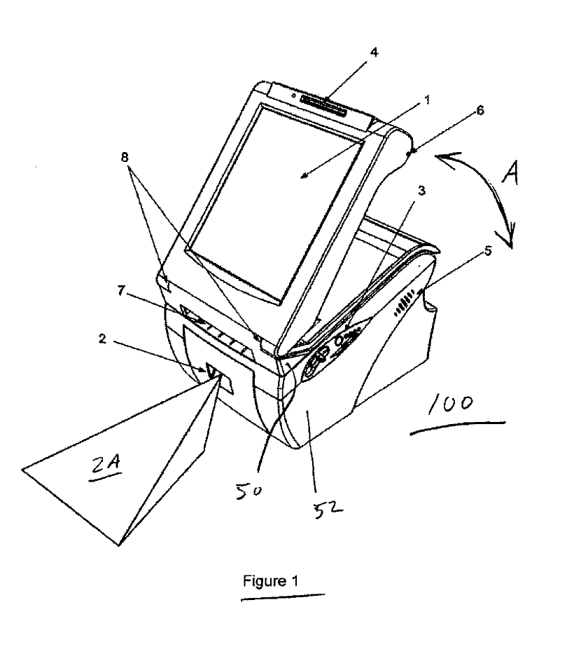

Referring now to FIGS. 1-5, one embodiment of the present invention is shown. As seen in these Figures, terminal 100 may include touch screen 1 (used, for example, by an operator to pick and play lottery games via the appropriate lottery application). In one specific example, touch screen 1 may be a 8.4″ colored TFT LCD touch screen with 600×800 resolution. In another specific example, touch screen 1 may be disposed in portrait alignment and touch screen 1 may have a wide viewing angle. Of note, touch screen 1 may be mechanically attached to printer cover 50 in such a way (see, e.g., hinges 8) as to permit the operator to choose any desirable inclination for the terminal's best operation (that is, to permit the operator to rotate touch screen 1 around hinges 8 (see arrows “A” of FIGS. 1, 3 and 5) to any desired orientation). In one example, hinges 8 may include one or more detents to hold touch screen 1 in one or more predetermined orientations. In another example, hinges 8 may allow for essentially unlimited adjustability between two endpoints.

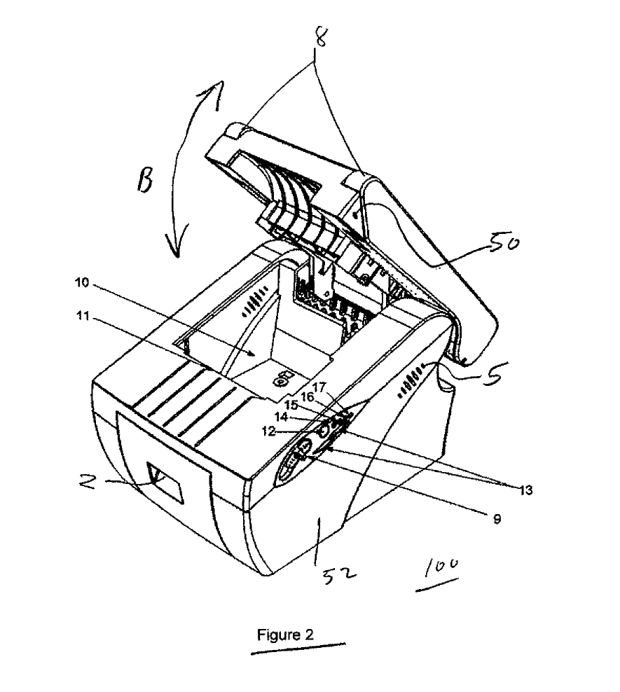

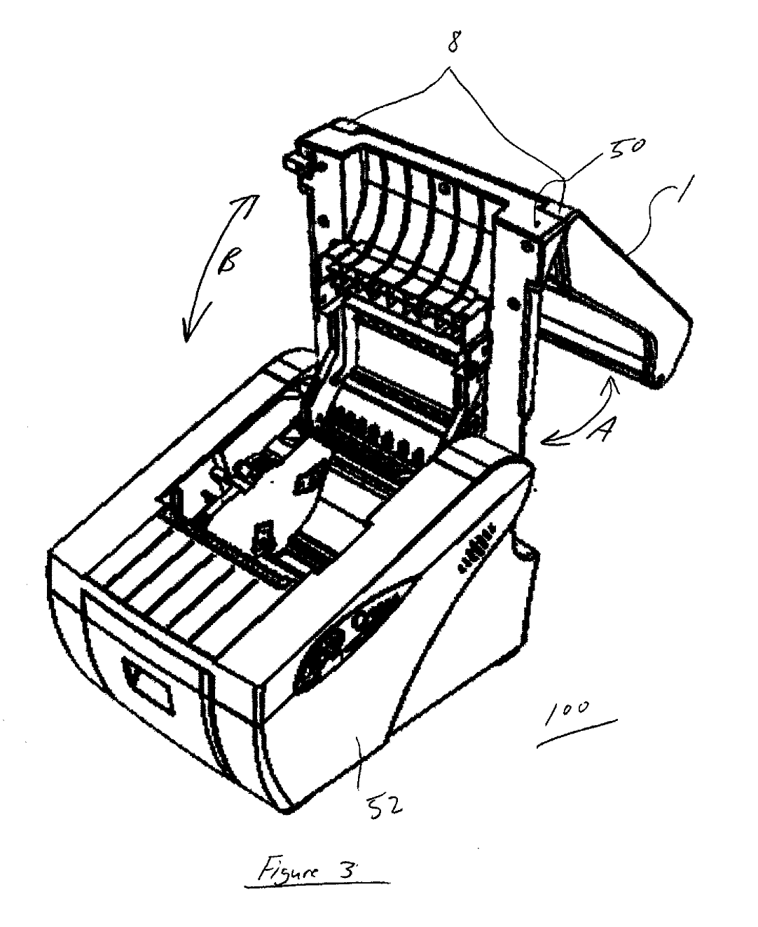

Further, printer cover 50 may be mechanically attached to base 52 in such a way (e.g., via hinges (not separately called out in the Figures)) as to permit the operator to open printer cover 50 for changing the printer paper (see, e.g., arrows “B” of FIGS. 2 and 3). In one example, the hinges attaching printer cover 50 to base 52 may include one or more detents to hold printer cover 50 in one or more predetermined orientations. In another example, the hinges attaching printer cover 50 to base 52 may allow for essentially unlimited adjustability between two endpoints.

Of note, FIG. 2 shows printer cover 50 rotated into an open position (e.g., in order to insert a roll of printer paper) while touch screen 1 is in a down position adjacent printer cover 50.

Of course, touch screen 1 could be left in any desired raised orientation (see, e.g., the orientation of FIG. 3) while printer cover 50 is rotated into an open position. In other words, printer cover 50 may be rotated into an open position (and then closed) independently, without the need to adjust the inclination of touch screen 1.

In another example, barcode reader 2 (e.g., a 1D or 2D selectable barcode reader) may be adjacent the front side of terminal 100. In this example, barcode reader 2 may provide fast read, check, and validation not only of lottery slips/tickets/receipts but also of products (e.g., acting as a retail POS terminal) In another example, barcode reader 2 may operate without the need for moving any of the parts of terminal 100 (see, e.g., example coverage area 2A of FIG. 1).

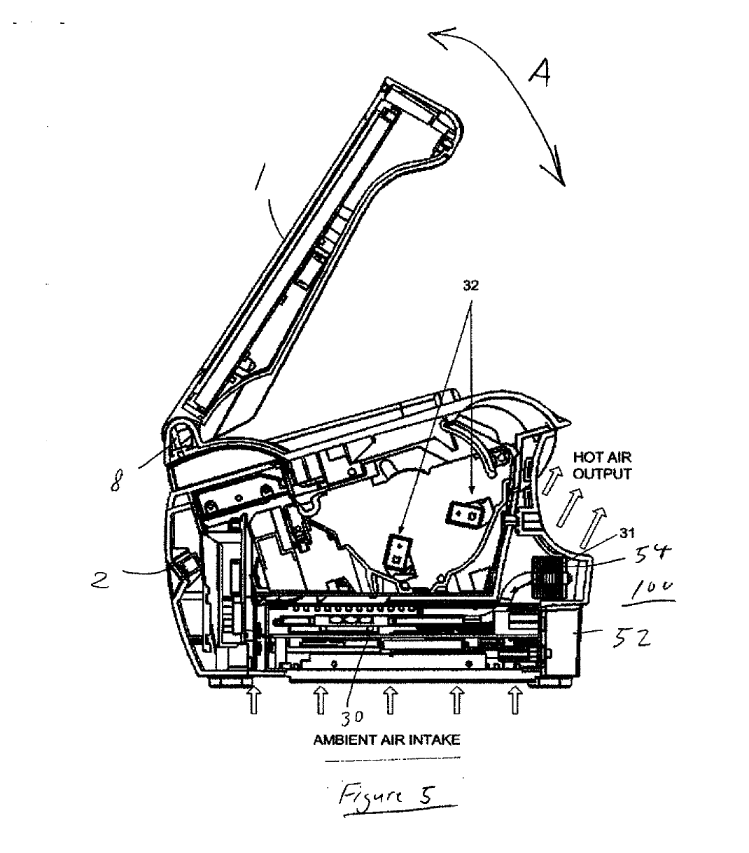

In another example, control panel 3 may be placed on terminal 100 (e.g., on the right side of terminal 100) and may provide information regarding the status of terminal 100. Control panel 3 may also provide various buttons and levers for controlling the electrical and/or mechanical parts of terminal 100. In one specific example, there may be provided: button 12 to advance the paper through the printer; buttons 13 for controlling the brightness of touch screen 1; indication LEDs 14,15,16,17 for a standby status of terminal 100 for booting from a LAN, a low paper indicator, a printer paper error (e.g., due to printer sensors 32 (see FIG. 5)), and for a power supply indicator.

Further, with the aid of lever 9 the operator can easily access the inner portion 10 of the printer (e.g., for paper change). The printer may be a thermal printer and the printer structure may be designed for easy paper installation (e.g., the operator may need only drop the paper into the printer in the appropriate direction).

Further still, with the integrated smart card reader 4 (which may read/write magnetic and/or digital memory cards) the operator may have the ability to use smart cards for any kind of use and transaction requiring such cards.

Further still, integrated speakers 5 on both sides of terminal 100 give the ability to generate sounds and messages for the customer and/or the operator depending on the loaded software.

Further still, detaching the stylus pen 6 (e.g., located at the back-top of the touch screen 1), the operator is able to make accurate touches and micro-adjustments on touch screen 1.

Further still, the printer's paper outlet 7 may be equipped with a manual/auto cutter 11 (which may be of a sophisticated design such as to provide fast ticket/receipt removal).

Despite the small size of motherboard 30 the CPU installed thereon may, of course, provide enough power to fulfill the needs of lottery and/or monetary applications.

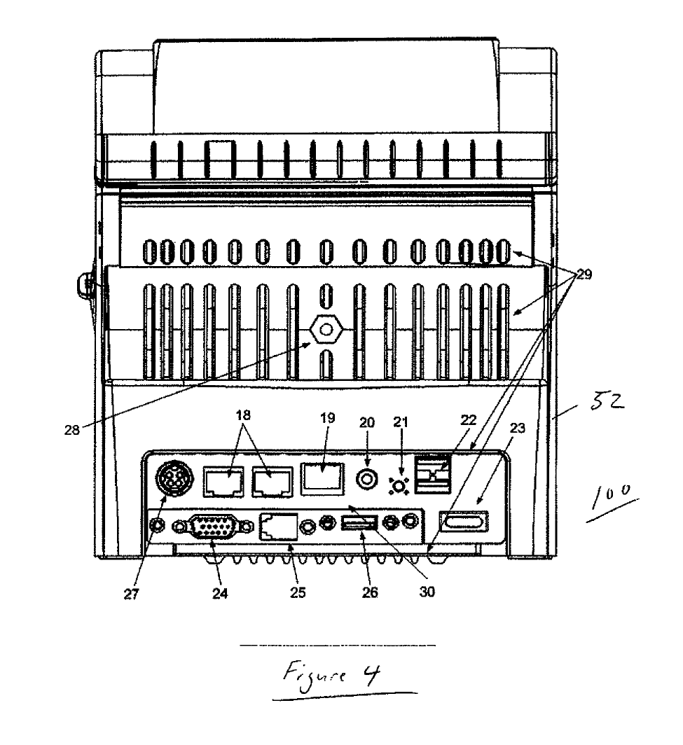

Referring now to FIG. 4 in particular, a rear panel of terminal 100 including various ports for the terminal's expandability is shown. In the example of this FIG. 4, the basic configuration of the rear panel of terminal 100 includes two serial ports 18, LAN connection 19, stereo audio output 20, reset button 21, two USB ports 22, and the main on/off switch 23.

Depending on the application requirements, terminal 100 may have an expansion bracket that can be equipped, for example, with one USB port 26 and cash drawer control 25. Moreover, a mini PCI slot on the CPU card may offer the ability for connecting any type of mini PCI cards such as wireless LAN cards and/or secondary VGA cards 24 (e.g., for driving a TFT, LCD, or plasma customer display).

An external power supply unit may be provided for connection to the appropriate power connector (see callout number 27 of FIG. 4).

The overall internal and external design of terminal 100 may provide natural ventilation (see, e.g., ventilation holes 29 of FIG. 4) without the need for the fans typically used.

Further, various embodiments of the present invention may provide protection (see, e.g., screw 28 of FIG. 4) from access by unauthorized persons to specific parts of terminal 100 (such as special memories) and may thus be suitable for monetary applications. In this regard, access to the inside of the lottery terminal (e.g., access to read-only flash memory for monetary transactions, M/B changes and/or any other secure elements) may be prohibited without removal of screw 28 (which may be tamper-proof and/or tamper evident, such as by being lead sealed).

In another example of the present invention a low-end terminal that is designed basically for lottery applications may be provided. The lottery terminal of this example may comprise a colored LCD TFT touch screen, a thermal printer, a smart card reader, a stylus pen, a barcode reader, a pair of speakers and a control panel (including, for example, indicator LEDs, control buttons and a handling lever for controlling not only the printer and the display but also the rest of the terminal). The lottery terminal may be designed in such a way that the touch screen and the printer cover can provide a double inclination (e.g., the printer cover may be attached to a base and may pivot relative to the base and the touch screen may be attached to the printer cover and may pivot relative to the printer cover). This double inclination may serve not only to conserve space, but also to give the ability to the operator to open the printer cover for changing the printer paper without the need for adjusting the display's inclination.

In one specific example, the touch screen may determine the overall width of the lottery terminal (see, e.g., FIG. 1). In other words, the lottery terminal may be as narrow as the touch screen (or as narrow as any framing/mounting assembly associated with the touch screen).

In another specific example, the cooling system for the CPU and the chipset may comprise a heat sink with a heat pipe configuration (see heat pipe 31 and heat sink 54 of FIG. 5). This may provide the lottery terminal the ability to utilize natural or passive ventilation—leading the overall produced heat to specially designed slots (e.g., at the rear of the lottery terminal) without the need for fans.

In another specific example, the smart card reader placement (see, e.g., FIG. 1) may allow the use of smart cards without interrupting the use of the rest of the lottery terminal peripherals.

In another example, the lottery terminal may be used as an autonomous point-of-sale terminal and/or as a cash register (e.g., the lottery terminal external material and configuration may be designed to provide security for monetary transactions).

Of note, the embodiments described herein may, of course, be implemented using any appropriate computer hardware and/or computer software. In this regard, those of ordinary skill in the art are well versed in the type of computer hardware that may be used (e.g., a mainframe, a mini-computer, a personal computer (“PC”), a network (e.g., an intranet and/or the Internet)), the type of computer programming techniques that may be used (e.g., object oriented programming), and the type of computer programming languages that may be used (e.g., C++, Basic, AJAX, Javascript). The aforementioned examples are, of course, illustrative and not restrictive.

While a number of embodiments of the present invention have been described, it is understood that these embodiments are illustrative only, and not restrictive, and that many modifications may become apparent to those of ordinary skill in the art. For example, certain methods may have been described herein as being “computer implementable” or “computer implemented”. In this regard, it is noted that while such methods can be implemented using a computer, the methods do not necessarily have to be implemented using a computer. Also, to the extent that such methods are implemented using a computer, not every step must necessarily be implemented using a computer. Further, the lottery terminal may comprise metal and/or plastic components. Further still, the various steps may be carried out in any desired order (and any desired steps may be added and/or any desired steps may be eliminated).

What is claimed is:

1. A lottery terminal, comprising:
a lottery terminal base;
a printer cover portion having a first end and a second end, wherein the first end of the printer cover portion is rotatably mounted to the base; and
a touch screen portion having a first end and a second end, wherein the first end of the touch screen portion is rotatably mounted to the second end of the printer cover portion such that the touch screen portion is carried along with the printer cover portion when the printer cover portion is rotated relative to the base, wherein the touch screen portion is rotatable relative to the printer cover portion independently of a position of the printer cover portion relative to the base, and wherein the printer cover portion is rotatable relative to the base independently of a position of the touch screen portion relative to the printer cover portion.

2. The lottery terminal of claim 1, wherein a rotation of the printer cover portion relative to the base is around a first pivot axis, wherein a rotation of the touch screen portion relative to the printer cover portion is around a second pivot axis, and wherein the first pivot axis and the second pivot axis are parallel with one another.

3. The lottery terminal of claim 1, wherein the first end of the printer cover portion is rotatably mounted to the base via at least one hinge.

4. The lottery terminal of claim 1, wherein the first end of the touch screen portion is rotatably mounted to the second end of the printer cover portion via at least one hinge.

5. The lottery terminal of claim 4, wherein the touch screen portion is mounted in a portrait orientation relative to the at least one hinge.

6. The lottery terminal of claim 1, wherein the touch screen portion comprises a colored TFT LCD touch screen.

7. The lottery terminal of claim 1, further comprising at least one of: (a) a printer; (b) a magnetic card reader; (c) a digital memory card reader; (d) a touch screen stylus pen; (e) a barcode reader; (f) at least one speaker; and (g) a control panel.

8. A lottery terminal, comprising:
a bottom portion of a lottery terminal, wherein the bottom portion has at least one ambient air intake vent hole therein;
at least one wall extending generally upward from the bottom portion, wherein the at least one wall has at least one hot air output vent hole therein;
a CPU; and
a heat sink operatively attached to the CPU;
wherein the heat sink is disposed in the lottery terminal at a position to have heat removed by an air flow traveling from the at least one ambient air intake vent hole to the at least one hot air output vent hole; and
wherein the lottery terminal has no cooling fan and the air flow is produced by the heat radiated from the heat sink.

9. The lottery terminal of claim 8, wherein the lottery terminal has no cooling fan and the air flow is produced by the heat radiated from the heat sink and the CPU.

10. The lottery terminal of claim 8, further comprising a motherboard upon which the CPU and a plurality of ancillary components are mounted.

11. The lottery terminal of claim 10, wherein the lottery terminal has no cooling fan and the air flow is produced by the heat radiated from the heat sink, the CPU and the ancillary components of the motherboard.

12. The lottery terminal of claim 8, further comprising a plurality of ambient air intake vent holes in the bottom portion.

13. The lottery terminal of claim 8, further comprising a plurality hot air output vent hole holes in the at least one wall.

14. The lottery terminal of claim 8, wherein the heat sink is operatively attached to the CPU by a heat pipe.

15. The lottery terminal of claim 8, wherein the at least one wall comprises a rear wall.
